(19) United States
(12) Patent Application Publication
(10) Pub. No.: US 2014/0017459 A1
(43) Pub. Date: Jan. 16, 2014

(54) Temporarily Positionable Meltable Adhesives For Shoe And Apparel Assembly

(71) Applicants: Carrie L. Davis, Portland, OR (US); Ruzica Krstic, Portland, OR (US); Amy Lyttle, Portland, OR (US)

(72) Inventors: Carrie L. Davis, Portland, OR (US); Ruzica Krstic, Portland, OR (US); Amy Lyttle, Portland, OR (US)

(73) Assignee: NIKE, INC., Beaverton, OR (US)

(21) Appl. No.: 13/549,025

(22) Filed: Jul. 13, 2012

Related U.S. Application Data
(63) Continuation-in-part of application No. 13/545,681, filed on Jul. 10, 2012.

(51) Int. Cl. B32B 37/12; B32B 7/12; B32B 7/14; B32B 41/00

(52) U.S. Cl. 428/200; 156/64; 428/411.1

(57) ABSTRACT

Layers of an item may be temporarily assembled using a tacky surface on an adhesive layer. The adhesive layer may be activated by the application of energy to cause it to partially or entirely melt to bond layers together. The tacky layer may permit layers to be moved after initial positioning if the positioning is not acceptable. A tacky layer may cover all or part of the surface of an adhesive layer to permit the adhesive to flow without hindrance when activated.

### CROSS-REFERENCE TO RELATED APPLICATIONS

This application is a continuation-in-part of U.S. patent application Ser. No. 13/545,681, filed Jul. 10, 2012, entitled “Temporarily Positionable Meltable Adhesives For Shoe And Apparel Assembly,” which is herein incorporated by reference.

### FIELD

The present invention relates to materials, systems, and/or methods for adhering layers in the assembly of shoes, apparel, equipment, or other items. More particularly, the present invention relates to hot melt adhesive films with at least one side entirely or partially coated with adhesives that permit the film to be temporarily and moveably adhered to a surface to be bonded using the film.

### SUMMARY

The assembly of shoes, apparel, and various types of accessories or equipment made of pliable materials often involves using adhesive films. Often, these adhesive films are at least partially melted during the assembly process to enable them to flow into the layers of material, such as textiles, above and/or below the adhesive film. For example, a film may be of a type sometimes referred to as a “hot melt” that will partially melt when heated, although films known as “cold melts” are also known, and some films may be activated with pressure and/or ultrasonic energy in addition to or instead of heat. A typical process of assembly may comprise stacking a base layer material, followed by an adhesive layer, followed by a top layer to be adhered to the base layer; after stacking a heat press or other device may be used to activate the adhesive layer to bond the base layer and the top layer together. While this process is straightforward in the case of a simple design, when an item being manufactured is complicated the proper alignment of numerous elements in stacking may be exceptionally challenging. Meanwhile, because the adhesive layer, once activated, cannot be deactivated, an incorrectly stacked item must ultimately be discarded, resulting in undesirable waste.

The present invention provides materials, systems, and methods that facilitate the assembly of shoes, apparel, equipment, accessories, or any other item using sheet adhesives. A tack layer may be added to one or both sides of the adhesive layer. The tack layer may be adhesive, glue or other material that is active at temperatures different than the adhesive layer. For example, the adhesive layer may be activated to flow and form a bond at a first temperature, while the tack layer may be active to form a bond at a second temperature, the second temperature being lower than the first temperature. For example, the tack layer may be activated at room temperature, enabling it to at least lightly adhere to compatible surfaces with not additional application of heat, pressure, ultrasonic energy, etc., while the adhesive layer may be activated only by the application of additional energy. Accordingly, the tack layer may be used to temporarily position the adhesive layer before the adhesive layer is activated. The strength of the bond formed by the tack layer may be considerably less strong than the bond formed by the adhesive layer, such that the bond formed by the tack layer may be readily severed if, for example, parts being temporarily assembled are discovered to be improperly aligned prior to the activation of the adhesive layer.

A tack layer may be provided on all or part of a surface of an adhesive layer. For example, a tack layer may only partially cover a side of the adhesive layer so as to not physically or chemically interfere with the flow of the adhesive layer when the adhesive layer is activated. The tack layer may be applied in a pattern of dots, stripes, a checkerboard, etc. in order to function as a temporary adhesive while still permitting the adhesive layer to flow when activated. If desired, opposing surfaces of the adhesive layer may have different types of tack layers, for example to provide different strengths of temporary bonds or to engage different types of materials, and/or opposing surfaces of the adhesive layer may have a tack layer provided in a different pattern. Further, one or both surfaces of an adhesive layer may be rendered tacky by forming the adhesive layer mixing at least two compounds, a first compound comprising an activatable adhesive and the second compound comprising a tacky material, thereby creating a combined activatable adhesive/tack layer.

The adhesive layer may be a completely separate item in the stacking process, but the adhesive layer may also be provided as integral to another sheet material intended to be a component of the finished product. For example, a layer for inclusion in an assembled item may be provided with an adhesive layer integral to one face of the sheet. The sheet may be a woven or knit textile, a film, a synthetic material, or other sheet type material. In such an example, the face of the integral adhesive layer facing away from the sheet material may have a tack layer to permit it to be temporarily adhered to a base layer or any other layer of material in the assembly process.

The present invention also provides methods of assembling an item using an adhesive layer with at least one tack layer on at least a first surface of the adhesive layer. Such a method may comprise forming or selecting the desired pieces for assembly, temporarily assembling the pieces using the tack layer(s) to temporarily secure the pieces together, inspecting the assembly, and then activating the adhesive layer if the assembly is acceptable.

This section provides a general summary of the disclosure, and is not a comprehensive disclosure of its full scope or all of its features. Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 illustrates the assembly of layers of materials in accordance with an example of the present invention;

FIG. 2 illustrates an example of layers of materials in accordance with the present invention temporarily assembled for inspection;

FIG. 3 illustrates a further example of layers of materials in accordance with the present invention temporarily assembled for inspection;

FIG. 4 illustrates an example of a tack layer pattern in accordance with the present invention;

FIG. 5 illustrates a further example of a tack layer pattern in accordance with the present invention;

FIG. 6 illustrates a further example of a tack layer pattern in accordance with the present invention;

FIG. 7 illustrates a further example of a tack layer pattern in accordance with the present invention;

FIG. 8 illustrates a method of assembling layers of an item in accordance with the present invention;

FIG. 9 illustrates a further method of assembling layers of an item in accordance with the present invention;

FIG. 10 illustrates a cross section of an example of a tacky activatable adhesive in accordance with the present invention;

FIG. 11 illustrates a cross section of a further example of a tacky activatable adhesive in accordance with the present invention;

FIG. 12 illustrates a cross section of a further example of a tacky activatable adhesive in accordance with the present invention;

FIG. 13 illustrates a cross section of an example of a tacky activatable adhesive and a second material in accordance with the present invention; and

FIG. 14 illustrates a cross section of a further example of a tacky activatable adhesive and a second material in accordance with the present invention.

Corresponding reference numerals indicate corresponding parts throughout the several views of the drawings.

### DETAILED DESCRIPTION

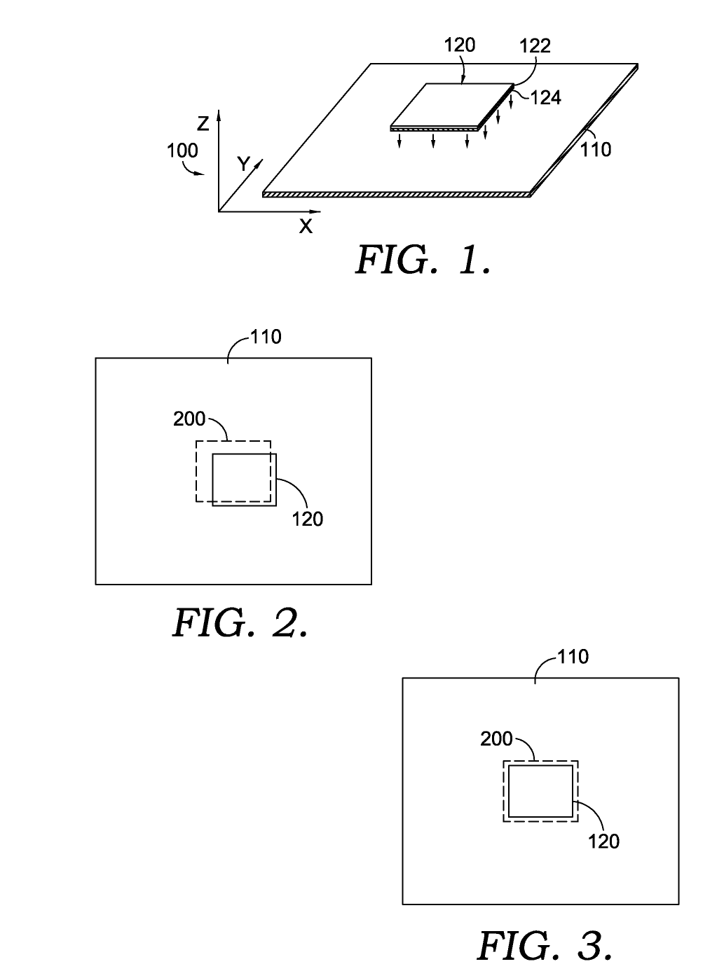

Referring now to FIG. 1, a base layer 110 may be positioned in a three-dimensional space defined, for example, using an x, y, z coordinate system 100. A second layer 120 may be positioned upon base layer 110 as part of the assembly process of a completed item. Second layer may have an adhesive layer 122 that may be activated by the application of energy, such as heat, pressure, ultrasonic energy, etc. A tack layer 124 may be provided on adhesive layer 122 facing base layer 110 in the orientation desired for assembly. As indicated by arrows, second layer 120 may be positioned by stacking it on to base layer 110.

Referring now to FIG. 2, the partially assembled item of FIG. 1 is shown in during an inspection to determine whether second layer 120 has been properly stacked on to base layer 110. For example, inspection standards may define zone 200 within which second later 120 must be positioned. While zone 200 is indicated using a dashed line, zone 200 and similar zones used for inspections in accordance with the present invention need not be temporarily or permanently marked on any layer or item in the assembly process. A zone such as zone 200 may be indicated using projection techniques or provided for electronically or in software as part of an automated inspection system. Further, a zone such as zone 200 may be defined relative to other aspects of an item, such as an edge of base layer 110, or may even be provided using a template or overlay utilized to facilitate inspection of partially assembled items.

Regardless as to how zone 200 is defined, as illustrated in FIG. 2 second layer 120 may not be appropriately positioned. In the present example, which is provided for illustrative purposes only, second layer 120 extends out of zone 200 along two sides. Accordingly, second layer 120 may be removed from base layer 110 by severing the connection formed by tack layer 124. Second layer 120 may then be repositioned, such as illustrated in the example of FIG. 3. As illustrated in FIG. 3, second layer 120 is now wholly positioned within zone 200. Accordingly, the partially assembled item illustrated in FIG. 3 may be permanently assembled by activating adhesive layer 122.

A variety of materials may be used as a base layer and/or a second layer. For example, woven textiles, knit textiles, foams, natural leather, synthetic leather, films, non-woven reinforcing materials, meshes, and the like may be used in accordance with the present invention. Woven and/or knit textiles may comprise any type of natural or synthetic fibers, such as polyester, nylon, cotton, etc. Foams may be PU, EVAs, phylons, or of any other type. Films may comprise PU films, TPU films, or any other type of film material. While systems and methods in accordance with the invention may be used to bond two similar or different layers of pliable sheet type materials, non-pliable or non-sheet type materials may be bonded together in a layered arrangement in accordance with the present invention.

Further, a variety of materials may be used for an adhesive layer. The material used for an adhesive layer in accordance with the present invention may be selected based, at least in part, upon the types of materials to be permanently bonded together, i.e., the base and second materials as described in the examples herein, and based, at least in part, upon the strength of bond ultimately desired between the base material and the second material. Examples of acceptable materials are often referred to as “hot melt” or “PSA” or “PSA/hot melt” adhesives, although other types of activatable adhesive materials may be used as well. Different adhesive materials may require processing at different temperatures and/or pressures, for example at 110 degrees centigrade, 115 degrees centigrade, 118 degrees centigrade, 120 degrees centigrade, 122 degrees centigrade, 125 degrees centigrade, 130 degrees centigrade, etc, potentially with the temperature controlled to varying degrees, such as to within 2 degrees. Processing times may vary based upon the type of material used for the adhesive layer, the materials used for the base layer and the second layer, the thicknesses of the various materials used, the process temperature and/or pressure, the strength of bond ultimately desired, etc. Process times may be, for example, 30 seconds, 45 seconds, etc. Pressure applied may be, for example, approximately 5.5 kilograms per square centimeter, but more or less pressure may be used. An adhesive layer may have any thickness, such as between 0.1 and 0.5 millimeters, such as 0.2 or 0.3 millimeters.

Similarly, the amount of temporary bonding strength provided by the tack layer may be varied both by the selection of the material(s) used to form the tack layer and the arrangement of that material upon the adhesive layer. A material for the tack layer may be selected to provide the desired flexibility throughout the expected life of the item and to not create marking on a base layer or second layer of an item when a layer is repositioned if such marking is not acceptable in a finished item. A tack layer may comprise a pressure sensitive adhesive (“PSA”) a glue or other adhesive that is active under conditions that do not activate the adhesive layer. Depending upon the types and configurations of materials to be temporarily bonded using a tack layer, different bonding strengths may be desired. Further, different patterns may be desired for the tack layer to permit different bonding behaviors by the adhesive layer upon ultimate activation. If an adhesive layer is provided separate from the base layer and the second layer, the adhesive layer may have two tack surfaces, one to engage the base layer and one to engage the second layer; in such an example, different materials and different patterns may be used for the different tack layers. A few examples of the potentially infinite arrangements of a tack layer are illustrated and described herein.

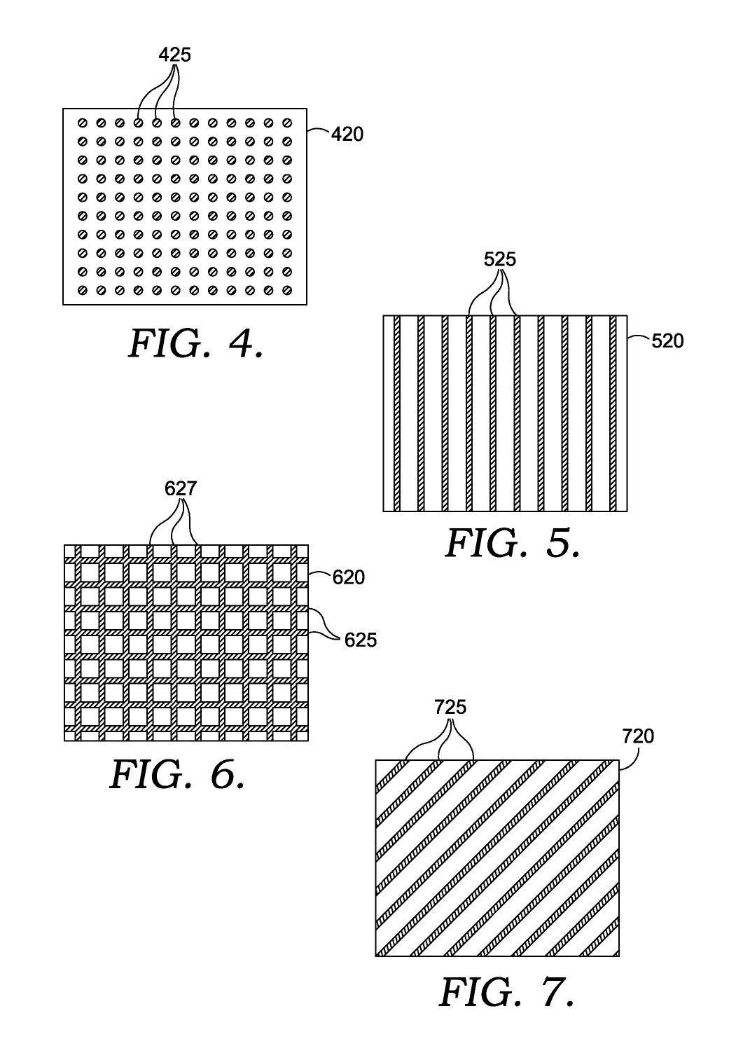

Referring now to FIGS. 4-7, various examples of possible arrangements of a tack layer over in adhesive layer are illustrated. In the examples illustrated in FIGS. 4-7, a tack layer is provided that maintains gaps or openings to permit the adhesive layer to engage other layers of materials during the assembly process without physical or chemical interference from the tack layer. Alternatively/additionally, a tack layer may be provided within gaps or openings within the adhesive layer, thereby enabling a tack layer and an adhesive layer to coextend in substantially the same plane while having discrete zones of tacky material and activatable adhesive.

For example, FIG. 4 illustrates a tack layer comprising a plurality of dots 425 arrayed over adhesive layer 420. In the example illustrated in FIG. 5, a tack layer is provided in a plurality of stripes 525 arranged extending vertically over adhesive layer 520. In yet a further example illustrated in FIG. 6, a tack layer comprising a first plurality of horizontal stripes 625 and a second plurality of intersecting vertical strikes 627 or provided over adhesive layer 620. In yet a further example of FIG. 7, a tack layer comprises a plurality of diagonal stripes 725 over adhesive layer 720. As can be appreciated from these examples, a tack layer may be provided over and adhesive layer in any of an endless variety of possible configurations. The precise ratio of tack layer relative to exposed adhesive layer may vary depending upon the materials used for the tack layer, the adhesive layer, and other layers to be bound using the adhesive layer. Further, different ratios of tack layer to exposed adhesive layer may be desired for different types of items that are expected to be exposed to different types of force, thereby requiring different strengths of permanent bonds. For example, ornamentation may not ultimately be subjected to show wrong forces during use, thereby requiring little or no exposed adhesive layer to attain sufficient bonding from the adhesive layer to permit the final item to function properly, while a functional component of and athletic shoe may be subjected to considerable forces during the expected use of the shoe, thereby requiring a judicious selection of materials and ratios of tack layer to exposed adhesive layer in order for the finished shoe to meet appropriate desired bonding strengths.

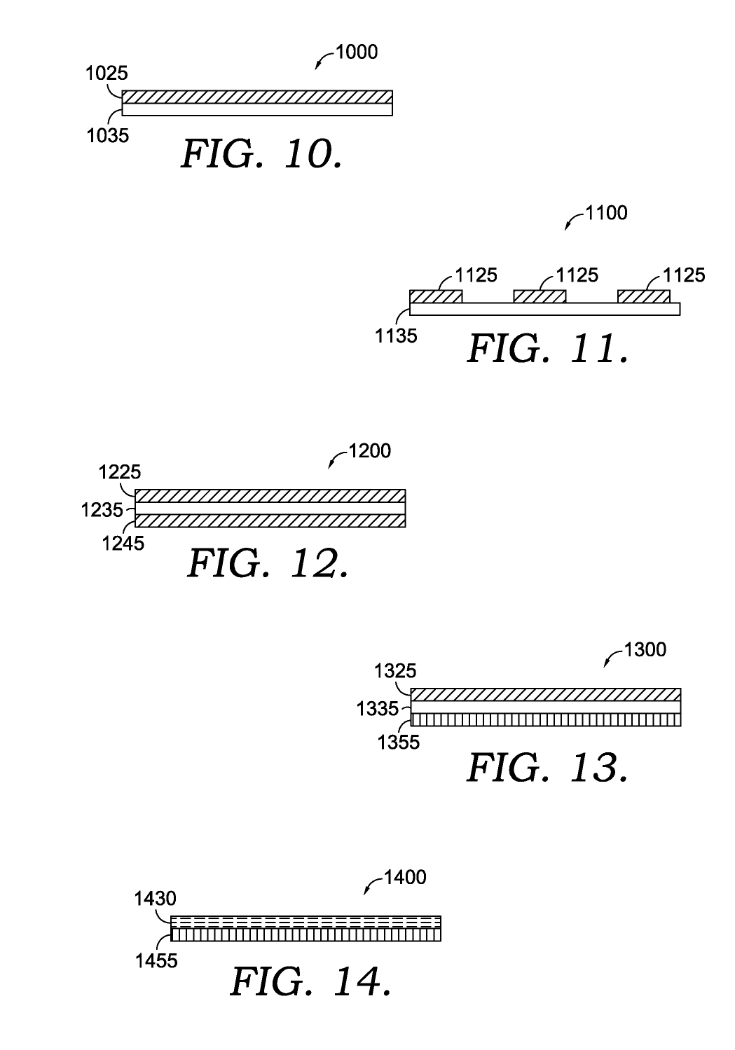

Cross sections of some examples of activatable adhesives with surface tack are illustrated in FIGS. 10-14. As shown in FIG. 10, a tack layer 1025 may extend over all or part of a surface of an activatable adhesive layer 1035 to form an activatable adhesive with surface tack 1000. As shown in the example of FIG. 11, an activatable adhesive with surface tack 1100 may comprise a patterned tack layer 1125 extending over all or part of a surface of an activatable adhesive layer 1135. Patterned tack layer 1125 may comprise any type of pattern, such as the examples described above with regard to FIGS. 4-7. Further, as shown in FIG. 12, an activatable adhesive with surface tack 1200 may comprise an activatable adhesive layer 1235 with a first tack layer 1225, which may be patterned, on a first surface and a second tack layer 1245, which may be patterned, on a second surface. By way of yet further example, FIG. 13 illustrates an activatable adhesive with surface tack 1300 comprising an activatable adhesive layer 1335 with a tack layer 1325, which may be patterned, on a first surface and a second material, such as a textile, sheet, etc., affixed to a second surface of the activatable adhesive layer 1335. Yet a further example of an activatable adhesive with surface tack 1400 is illustrated in FIG. 14, and may comprise a combined activatable adhesive/tack layer 1430, which may optionally be affixed to a second material such as a textile, sheet, etc. Combined activatable adhesive/tack layer may be formed by blending an activatable adhesive (such as hot melt polymer) with a tacky material (such as a pressure sensitive adhesive) and forming the resulting blend, which may contain other materials, into a sheet, membrane, or film.

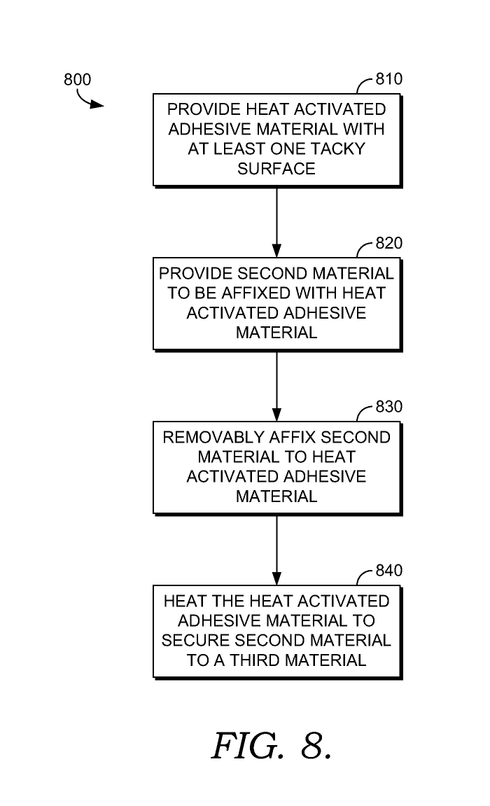

Referring now to FIG. 8, a method 800 for assembling layers oven item is illustrated. Method 800 may commence with step 810 of providing a heat activated adhesive material with at least one tacky surface. The tacky surface of the heat activated adhesive material provided in step 810 may comprise any of the arrangements illustrated in FIGS. 4-7 and/or FIGS. 10-14, or any other desired arrangement. Step 820 may comprise providing a second material, such as a base material, to be affixed with the heat activated adhesive material. In step 830 the second layer and the heat activated adhesive material may be removably or temporarily affixed using the tacky layer. In step 840 heat activated adhesive material may be activated through the application of heat to fix it to the second material.

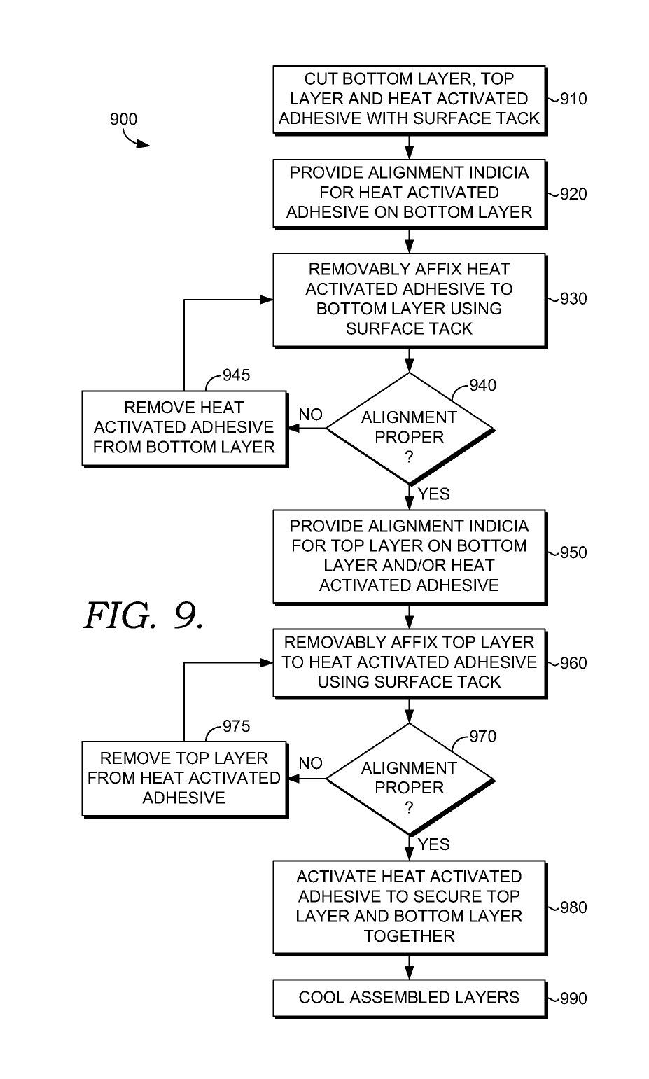

Referring now to FIG. 9, a further example of a method 900 in accordance with the present invention for assembling layers of an item is illustrated. In step 910 a bottom layer, top layer, and heat activated adhesive layer having at least one tacky surface may be cut as desired. The heat activated adhesive layer may, for example, be one of the examples illustrated in FIGS. 4-7 and/or FIGS. 10-12. In step 920 alignment indicia for the heat activated layer may be provided on the bottom layer. Step 920 may be performed by marking bottom layer, by projecting an indicia on bottom layer, using a template, or by any other means. In step 930 the heat activated adhesive layer may be removably affixed to the bottom layer using the tacky surface. In step 940 the alignment of the adhesive layer may be checked. If the inspection of step 940 is successful, method 900 may proceed to step 950. If the result of inspection step 940 is that adhesive layer is improperly aligned on bottom layer, method 900 may proceed to step 945 of removing heat activated adhesive layer from bottom layer and returning to step 930. Once method 900 reaches step 950, step 950 may comprise providing alignment indicia for the top layer on the bottom layer and/or the heat activated adhesive layer. As explained with regard to step 920, the alignment indicia provided in step 950 may be created in any way. In step 960 the top layer may be removably affixed to the heat activated adhesive layer using a tacky surface. In step 970 the alignment of the top layer may be inspected. If the alignment is unacceptable, method 900 may proceed to step 975 to remove the top layer from the heat activated adhesive, and then return to step 960. If inspection step 970 concludes that the top layer is properly aligned on adhesive layer, method 900 may proceed to step 980 of activating the adhesive layer to secure the top layer and bottom layer together. Finally, method 900 may conclude with step 990 of cooling the assembled layers.

Systems and methods of assembling layers of items in accordance with the present invention may depart from the examples illustrated and described herein. For example, various arrangements, configurations, shapes, and materials may be used. Further, steps of the methods in accordance with the present invention may be performed in orders departing from those illustrated herein.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. Such variations are not to be regarded as a departure from the invention, and all such modifications are intended to be included within the scope of the invention.

1. A method for assembling layers of an item, the method comprising:
providing a base layer of a pliable sheet type material;
providing a second layer of a pliable sheet type material to attach to the base layer;
providing an activatable adhesive layer, the adhesive layer having at least one tacky face;
stacking the adhesive layer onto the base layer;
stacking the second layer onto the adhesive layer;
using the at least one tacky face to form a bond temporarily retaining the stacked configuration of the base layer, the adhesive layer, and the second layer;
inspecting the stacked base layer, adhesive layer, and second layer to determine whether they meet predefined quality control standards;
if the stacked base layer, adhesive layer, and second layer do not meet the predefined quality control standards, severing the bond formed buy the tacky face temporarily retaining the stacked configuration and adjusting the positioning of at least one of the adhesive layer and the second layer and then repeating the inspecting of the stacked base layer, adhesive layer, and second layer;
if the stacked base layer, adhesive layer, and second layer meet the predefined quality control standards, activating the adhesive layer to permanently bond the base layer to the second layer.

2. The method of claim 1, wherein the step of providing an activatable adhesive layer having at least one tacky face further comprises providing a heat activatable adhesive layer having a tack layer on at least one face.

3. The method of claim 1, wherein the step of providing an activatable adhesive layer having at least one tacky face further comprises providing a heat activatable adhesive layer have a tack layer on both faces.

4. The method of claim 3, wherein at least one of the tack layers comprises an adhesive arranged in a pattern that covers only a portion of the face while allowing other portions of the face to contact one of the base material and the second material.

5. The method of claim 3, wherein both of the tack layers comprise adhesives arranged a pattern that cover only portions of the face while allowing other portions of the face to contact the base material and the second material, respectively.

6. The method of claim 5, wherein the tack layers comprise different adhesive types.

7. The method of claim 5, wherein the tack layers comprise the same adhesive type.

8. The method of claim 5, wherein the tack layers comprise adhesives arranged in the same pattern.

9. A method for assembling layers of an item, the method comprising:
providing a base layer of a pliable sheet type material;
providing a second layer of a pliable sheet type material to attach to the base layer, the second layer of sheet type material comprising:
an activatable adhesive layer affixed to one face of the second layer, and
a tack layer on the activatable adhesive layer;
stacking the second layer onto the base layer such that the tack layer forms a bond with the base layer temporarily joining the second layer to the base layer;
inspecting the stacked base layer and second layer to determine whether they meet predefined quality control standards;
if the stacked base layer and second layer do not meet the predefined quality control standards, severing the bond formed by the tack layer temporarily retaining the stacked configuration and adjusting the positioning of the second layer and then repeating the inspecting of the stacked base layer and second layer;
if the stacked base layer and second layer meet the predefined quality control standards, activating the adhesive layer to permanently bond the base layer to the second layer.

10. The method of claim 9, wherein the activatable adhesive layer comprises a heat activated adhesive layer.

11. The method of claim 10, wherein the tack layer comprises an adhesive applied in a pattern that covers only a portion of the adhesive layer while permitting other portions of the adhesive layer to contact the base layer.

12. The method of claim 11, wherein the pattern of the adhesive forming the tack layer comprises a plurality of equidistant dots.

13. The method of claim 11, wherein the pattern of adhesive forming the tack layer comprises an arrangement of stripes.

14. The method of claim 11, wherein the pattern of adhesive forming the tack layer comprises a checkerboard pattern.

15. The method of claim 11, wherein the step of activating the adhesive layer to permanently bond the base layer to the second layer comprises using a heat press to apply both heat and pressure to the base layer and the second layer in their stacked configuration.

16. A stacked item comprising:
a base layer, the base layer comprising a pliable sheet type material;
a second layer affixed to the base layer;
an activated adhesive layer affixing the second layer to the base layer;
a tack layer that temporarily bonded the second layer to the base layer prior to the activation of the adhesive layer, the tack layer comprising an adhesive that covered at least a portion of the adhesive layer while temporarily affixing the unactivated adhesive layer to at least one of the base layer and the second layer for a quality control inspection prior to activation of the adhesive layer.

17. The stacked item of claim 16, wherein the second layer further comprises a second pliable sheet type material.

18. The stacked item of claim 17 wherein the activated adhesive layer comprises an activated heat activatable material.

19. The stacked item of claim 18, further comprising a second tack layer, each of the tack layers comprising an adhesive arranged in a pattern that covered only a portion of each surface of the adhesive layer while permitting the other portion of the unactivated adhesive layer to contact the base layer and the second layer, respectively, while temporarily affixing the unactivated adhesive layer to the base layer and the second layer for a quality control inspection prior to activation of the adhesive layer

20. The stacked item of claim 16, wherein the activated adhesive layer was initially integral to the second layer.
